(19) United States
(12) Patent Application Publication
(10) Pub. No.: US 2008/0097842 A1
(43) Pub. Date: Apr. 24, 2008

(54) AUTOMATED MERCHANDISING NETWORK SYSTEM

(76) Inventors: Venkatakrishna TIRUMALA, Bangalore (IN); Pradeep JAVANGULA, San Jose, CA (US); Tony LOESER, Palo Alto, CA (US); James RICE, Redwood City, CA (US); Richard BILLINGTON, Palo Alto, CA (US); Simon HANDLEY, Palo Alto, CA (US); Bhavin DOSHI, Mountain View, CA (US)

Correspondence Address: GLENN PATENT GROUP, 3475 EDISON WAY, SUITE L, MENLO PARK, CA, 94025, US

(21) Appl. No.: 11/686,223

(22) Filed: Mar. 14, 2007

Related U.S. Application Data
(60) Provisional application No. 60/862,199, filed on Oct. 19, 2006.

(51) Int. Cl. G06Q 30/00

(52) U.S. Cl. 705/14

(57) ABSTRACT

An automated network merchandising system provides a platform for delivering relevant retail offers to interested consumers online. A backend content pipeline analyzes and processes delivered catalog content into a merchandisable universe of products (MUP). On a user-facing end, corner stores—ad units appearing on pages of publishers' web sites—display offers from the MUP. Publishers deploy store scripts to their web pages. The script runs in the user's browser, causing display of an interactive ad unit featuring product offers. An adaptive targeting engine produces targeted product offers based on the ad's display context, including at least user data, page analysis and geographic location. A targeting console allows marketers to specify campaigns targeted to particular corner store ad contexts. Campaigns are defined by combinations of product categories, merchants, price ranges and key words. A store builder allows publishers to specify campaigns to be displayed to web site visitors.

### CROSS REFERENCE TO RELATED APPLICATIONS

This application claims benefit of U.S. provisional patent application Ser. No. 60/862,299 filed Oct. 19, 2006, the entirety of which is incorporated herein by this reference thereto.

### BACKGROUND OF THE INVENTION

1. Field of the Invention

The invention generally relates to systems and methods for e-commerce. More particularly, the invention relates to an automated merchandising network system.

2. Background Information

Early forms of e-commerce such as EDI (electronic data interchange) and ETF (electronic funds transfer) first emerged in the mid-twentieth century. The development of the world-wide web and the general availability of broadband Internet access have been such potent stimulants to the proliferation of Internet-based e-commerce that Internet-based e-commerce has, in the present day, achieved institutional status.

As e-commerce has proliferated, methods of advertising and merchandising suited to e-commerce business models have begun to appear. The first banner ads appeared on Internet sites in 1994. Initially, these banner ads were statically assigned, wherein the advertisements in a page did not generally change unless a site administrator changed them. Later, ad servers, allowed the provision of banner ads that rotated automatically.

Pop-up ads, ads that appear in separate browser windows on top of the main page, began to appear in 2001.

Targeted or contextual advertising, allowed advertisers to key the ad displayed to a page visitor or to some sort of user profile. Machine learning approaches made it possible to adapt advertising and merchandising to the customer in real time.

Collaborative filtering techniques made it possible to enrich a user profile with attributes extracted from profiles of other similar users. Additionally, collaborative filtering was instrumental in enabling cross-merchandising, such as cross-selling and up-selling, in the online environment.

It has also become possible to further personalize the shopping experience by including geographic location in the user profile.

Targeted advertising has also been combined with affiliate marketing, a method of promoting businesses or products in which an owner of a partner web site—an affiliate—is rewarded for every visitor, subscriber, customer, and/or sale resulting from click-through traffic originating from the affiliate web site.

In the early days of Internet advertising, approaches such as banner advertising and pop-up advertising were found to be very effective. The ability to maintain log files on web servers provided advertisers with extremely accurate measurements of their ads' impact. Because the online environment made it possible to reach such a large audience, even incremental improvements in click-through rates could result in significant increases in traffic to an advertiser's web site. The ability to target advertising resulted not only in higher click-through rates, but higher conversion rates.

Consumers, however, are increasingly alienated by conventional Internet advertising techniques such as banner ads and pop-ups. More and more, ads are perceived as annoyances and a distraction from a web page's content. Additionally, tech-savvy consumers, in particular, resent what they perceive to be a waste of computing resources and bandwidth caused by conventional internet advertising such as banner ads and pop-ups.

Triggered by such widespread dissatisfaction, ad-filtering and ad-blocking software has become widely popular. In fact, browser manufacturers now provide browsers with the ad-filtering capability built in. Conventional Internet advertising methods have consequently lost much of their initial effectiveness, with click-through and conversion rates declining. There exists, therefore, a need in the art for systems and methods for less invasive Internet advertising that do not alienate or annoy the target audience while still providing high click-through and conversion rates.

Retailing in both off-line and on-line store space relies on practices that have evolved over several decades of discerning consumer behavior, supply chain interactions and event-driven personalized marketing campaigns.

Such merchandising practices may include:
organization of store space based on demographics, e.g. men's and women's apparel sections;
organizing store space by product category;
branded product aggregation on floor space, e.g. a POLO store, HP office automation product desk;
within departments and aisles, product promotion employs several approaches that include:
   seasonal promotions;
   product popularity promotions;
   stock and inventory driven promotions;
   marketing budget contributions from branded manufacturers;
   product promotion in high-traffic areas, e.g. end-caps and eye-level;
   a discount driven merchandising; and
   cross-selling and up-selling by placing related categories next to each other e.g. mobile phones and accessories; plants and containers.

While such merchandising practices are applicable in the online retail space, they are more difficult to implement because the process of shelf-space planning in the online space is considerably more complex than the same process in brick-and-mortar retail spaces. The scale and variety of online space available provide formidable analytical challenges for retail marketers. Nevertheless, such scale and complexity also present greater opportunity. There exists, therefore, a great need in the art for low-cost, low-touch systems and methods that assist product retailers and content publishers to take maximal advantage of the opportunities provided by online merchandising.

### SUMMARY

An automated network merchandising system provides a platform for delivering relevant retail offers to interested consumers online. At a backend, a content pipeline analyzes and processes delivered catalog content into a merchandisable universe of products (MUP). On a user-facing end, corner stores—ad units appearing on pages of publishers' web sites display offers from the MUP. Publishers deploy store scripts to their web pages. The script runs in the user's browser, causing display of an interactive ad unit featuring product offers. An, adaptive targeting engine produces targeted product offers based on the ad's display context, including at least user data, page analysis and geographic location. A targeting console allows marketers to specify campaigns targeted to particular corner store ad contexts. Campaigns are defined by combinations of product categories, merchants, price ranges and key words. A store builder allows publishers to specify campaigns to be displayed to web site visitors.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 provides a schematic diagram of an automated network merchandising system

FIG. 3 provides a schematic diagram of a content pipeline from the automated network merchandising system of FIG. 2;

FIG. 4 provides a schematic diagram of an ad-serving infrastructure from the system of FIG. 2;

FIG. 5 provides a schematic diagram of a publisher portal from the system of FIG. 2

FIGS. 6-10 provide screenshots of a user interface to a console for creating and managing a MUP (merchandisable universe of products);

FIGS. 11-14 provide screenshots of alternate embodiments of a user interface to an ad unit from the system of FIG. 2;

FIGS. 15-21 provide screenshots of a user interface to a publisher portal from the system of FIG. 2.

### DETAILED DESCRIPTION

### DEFINITIONS

Widget: also known within the context of the invention as an ‘ad unit.’ The widget or ‘ad unit’ is a windowed advertising unit that runs within the user's browser, designed to fit within constrained spaces on a page, such as the space that would be occupied by a banner ad. The widget constitutes a product search browser within the user's internet browser that presents categorized product offers to the user. The widget also provides interactivity elements such as such as ‘search’ and ‘browse’ capability. Additionally, the widget is self-optimizing in real time, producing an ad unit highly personalized to an individual user. An automated network merchandising system provides a platform for delivering relevant retail offers to interested consumers online. At a backend, a content pipeline analyzes and processes delivered catalog content into a merchandisable universe of products (MUP). On a user-facing end, corner stores—ad units appearing on pages of publishers' web sites display offers from the MUP. Publishers deploy store scripts to their web pages. The script runs in the user's browser, causing display of an interactive ad unit featuring product offers. An adaptive targeting engine produces targeted product offers based on the ad's display context, including at least user data, page analysis and geographic location. A targeting console allows marketers to specify campaigns targeted to particular corner store ad contexts. Campaigns are defined by combinations of product categories, merchants, price ranges and key words. A store builder allows publishers to specify campaigns to be displayed to web site visitors.

### System Overview

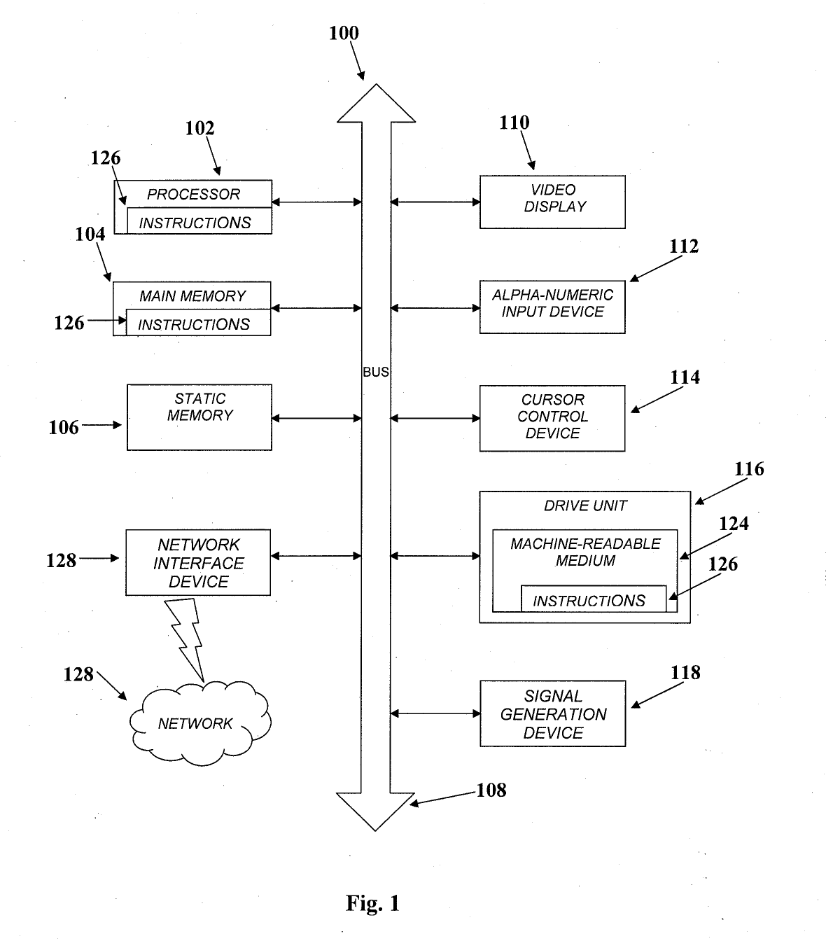

FIG. 1 shows a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 120.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 128 by means of a network interface device 120.

In contrast to the system 100 discussed above, a different embodiment of the invention uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

The automated network merchandising system may be thought of, essentially, as a matching engine that matches individual users browsing particular Web pages to the product offers from the retailers' and manufacturers' catalog content that is aggregated at the back end.

On one side of the equation is (1) a publisher, for example, a web site owner that is publishing a web site, for example a content web site, such as a newspaper or blog. Then, there is (2) the user who is experiencing the content by viewing and interacting with it through a web browser. Lastly, there is (3) the retailer who provides catalogs of product offers, and who is conveying merchandising rules, or other sorts of rules related, for example, to differentiating one product from another, or how the calendar affects the products the retailer intends to sell.

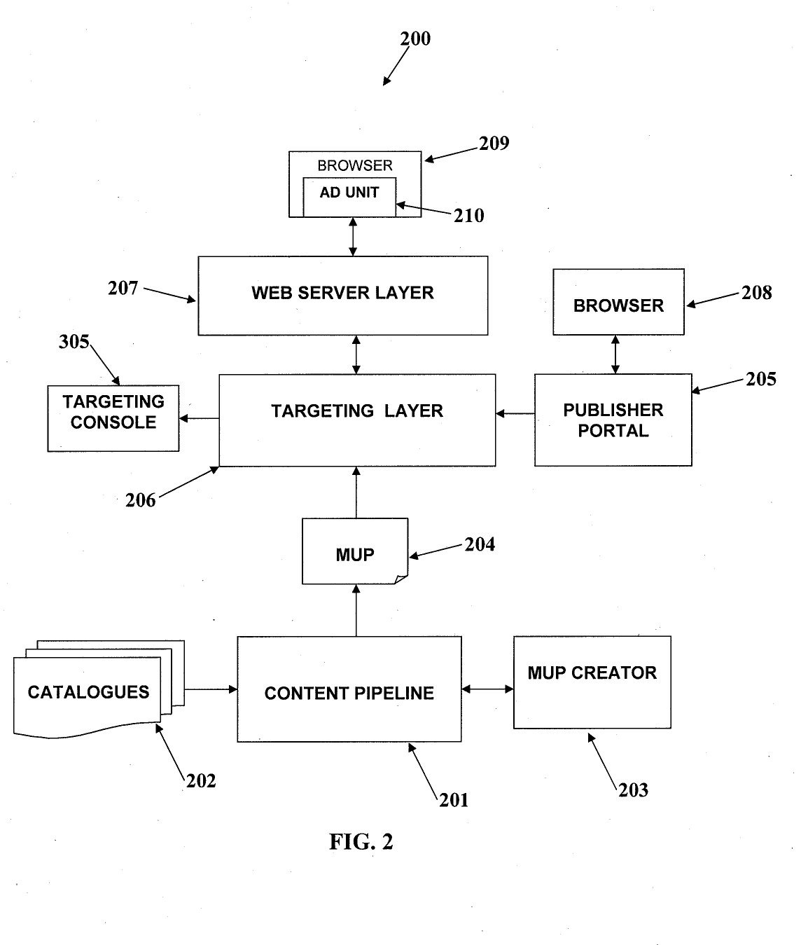

Referring now to FIG. 2, shown is a high-level schematic diagram of an automated product merchandising system 200.

Content, in the form of product catalogues 202, is retrieved, processed, analyzed and organized in a content pipeline 201 to prepare it for delivery to users appearing on the network. One embodiment of the invention performs a classification analysis of product offers, assigning each product offer to one or more product categories. The analysis process can also extract brand, price, and discount information from the product offers. Another embodiment of the invention uses latent semantic analysis to determine semantic relationships among the product offers and to organize them accordingly.

The ordinarily-skilled practitioner will understand that latent semantic analysis (LSI) is a technique for extracting and representing the similarity of meaning of words and passages in a body of content. Thus, by subjecting the retrieved catalog content to LSI, it is possible to identify latent themes or associations between and among product offers within the body of content that are not readily discernible using other methods of text analysis, such as key word analysis. In addition to recognizing keywords on a page, LSI searches all documents in the body of content, looking for similar terms. Documents that have many words in common are considered semantically close; documents with few words in common are considered to be semantically distant.

Returning now to FIG. 2, one or more MUPs 204 (merchandisable universe of products) are created from the analyzed, semantically organized content. As described in greater detail below, while millions of products may be included in the catalogs received from retailers, the system develops an optimized selection of the most appealing products—a “merchandisable universe of products” from the mass of product listings downloaded in the catalogs. It is from this MUP that product offers are ultimately selected for display in the ad units.

A person, typically someone associated with the network merchandising system, creates the MUP 204 by specifying parameters for the MUP 204 using a MUP creator 203, an interactive console by which the person accesses a store of analyzed, semantically organized content within the content pipeline 201.

A person, again typically someone associated with the network merchandising system, interacts with a targeting console 305 which is accessed by means of a client application such as a conventional web browser (not shown) and creates one or more targeting specifications that specify which products to show in particular ad units deployed around the web.

A content publisher, interacting with the system via a publisher portal 205, which can be accessed by means of a conventional web browser 208, also creates one or more targeting specifications that specify which products to show in ad units displayed on the pages of the content publisher's web site.

Based on the MUP and the targeting specifications, components in a targeting layer 206 dynamically choose products to display to the user by means of a widget, or ad unit 210, which is being viewed by the user as the user accesses the publisher's pages via a conventional web browser 209.

Components within a web server layer 207 serve up the widgets 210 displaying a selection of product offers in the client browser 209. Additionally, the web server layer components track user activity such as click-throughs and control the functionality and appearance of the widgets 210.

A more detailed description of the various components of the system follows. The ordinarily-skilled practitioner, in reviewing the following description, will appreciate that distinctions between the various functional units of the system are made for the sake of clarity and are not intended to be limiting. In actual fact, there can be considerable overlap between the various units. For example, the product selection engine is shown as a component in each of the content pipeline, the live service and the publisher portal.

The ordinarily-skilled practitioner will further appreciate that various computing arrangements are possible to support the functional units shown. For example, all or any portion of the units may be combined as discrete software components or logic circuits on a single computing device such as a server. In other embodiments, the functional elements may be distributed across a plurality of servers or other suitable computing devices in a variety of arrangements and configurations. All are within the scope of the invention.

### Content Pipeline

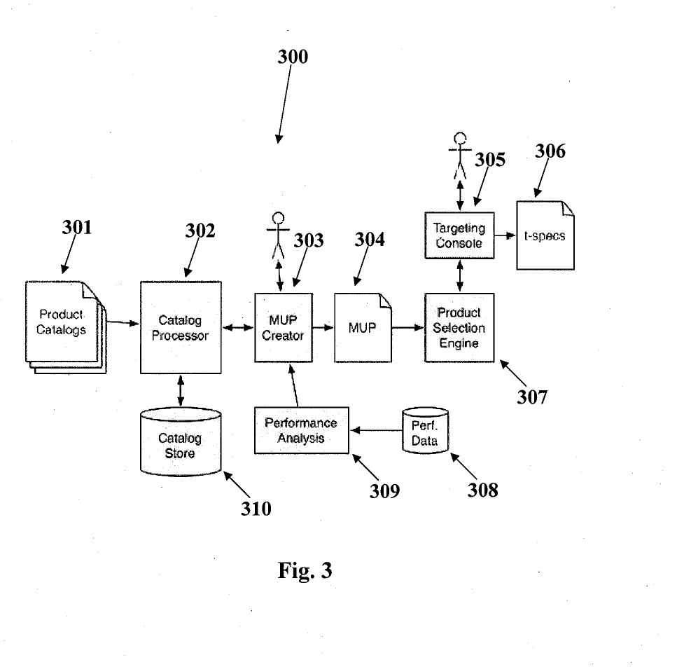

Referring now to FIG. 3, a more detailed description of the content pipeline is provided. The content pipeline serves as a backend where product catalogs come into the system. After processing, a merchandisable universe of products (MUP) is created from the catalogs. Content, in the form of product catalogs, is retrieved, processed, analyzed and semantically organized to prepare it for delivery to users that appear on the network.

Product catalogs 301 are obtained from retailer partners. In one embodiment, the system utilizes standard catalogs prepared for and distributed by retailers to affiliates. However, other catalog arrangements are within the scope of the invention. A catalog processor 302 loads and analyzes the catalogs, supports automated and human QA (quality assurance) processes and creates an overall merged set of product offers, and also serves as a parametric query engine for product offers.

The product catalogs come from a plurality of different retailers in different lines of business, each using different semantics. For example, SHARPER IMAGE (THE SHARPER IMAGE, San Francisco Calif.) may be seen as much more of specialty retailer compared to a company such as WAL-MART (WAL-MART STORES, INC., Bentonville Ak.). This distinction is important because the specialty retailer typically uses a finer-grained categorization to organize their products. Thus, in order to create the merged set of product offers it is necessary to assimilate fine-grained information as well as higher-level information. After such analysis, it is possible to merge the catalogs into a single entity—a MUP (merchandisable universe of products) 304. More is said about the MUP herein below.

A catalog store 310 serves as a long-term repository for the catalogs provided by the retailers and the product offers loaded from them.

A MUP creator 303 constitutes an interactive console whereby a user, for example, a user associated with the merchandising system, chooses the product offers that comprise the MUP. Using the MUP creator, the user can describe desirable characteristics for the MUP—for example, desirable product distributions and/or varieties. These user-determined settings form a set of constraints on the set of product offers that will comprise the MUP. Additionally, the MUP creator analyzes product offers, the metadata images associated with the product offer, prices, discount, special deal information, and other metadata in order to rank the candidates for inclusion in the MUP. An additional factor in development of a MUP is performance feedback supplied by a performance analysis component 309 using performance data 308 aggregated from service provider logs 408. Additionally, the performance analysis component analyzes the performance data in order to recommend settings, product white/black lists, or other input into the MUP creator 303. More is said about performance data below. Ultimately, the MUP comprises the product offers to which the MUP creator assigned a high rank value and that meet the constraints determined by the user-based and performance feedback-based settings.

The point behind the MUP, which is different from the union of all of the catalogs, is that it has been determined a priori that some products are better-suited for network-based merchandising or test marketing than others. For example, office supplies may not be a good fit for this kind of merchandising solution.

Similarly, price bands need to be taken into account in selecting product offers for the MUP 304. If a product is particularly expensive, costing more than $3,000 or $4,000, for example, then the propensity for a user to buy it on the web is limited. Similarly, the propensity for a user to make a web transaction for low-priced products is low because of the associated shipping cost. Thus, if the original price of the object is less than, for example, $10, it can be safely ignored from this universe of products to be merchandised. These price bands are determined explicitly through user settings, and also implicitly through performance feedback that will blacklist a product that hasn't done well (perhaps because it had a bad price) and whitelist a product that generates revenue.

There are factors that can be determined by the MUP creator's automated ranking process. For example, product offers that have a poor image, or flawed or missing metadata such as price. Automated analysis of images is necessarily based on heuristics. For example, are there enough color gradations, are there enough features in the image to make the image attractive; a single color, or black and white, or grayscale? If not, then it will not catch the end user's eye when it is displayed in the ad unit. These products offers are typically given a low rank from the MUP creator, and generally are not chosen unless specifically required by a constraint such as a whitelist.

Additional factors are taken into account in determining if a product is a good fit for the MUP 304, for example: the product's attractiveness, the merchant the product comes from; the propensity of the category into which this product belongs to result in a purchase; and past performance of the category in the merchandising network.

Additional merchant input is considered. For example, a merchant may insist on selling a particular category in spite of the fact that the category may not be a good fit for the MUP. Thus, the process of distilling the product catalogs into a MUP is driven by a body of rules that reflect the analytic activity.

Time sensitivity of the offer is another factor considered when evaluating a product offer. Offers that expire quickly, for example in one day, are not useful except in situations where the MUP is being updated at least as frequently, in this case daily.

Products are also evaluated to determine whether they provide opportunities for associative selling—cross-selling and upselling. For example, if a merchant is trying to sell a product, an IPOD (APPLE COMPUTER, INC., Cupertino Calif.) for example, it may be desirable to include IPOD accessories in the MUP, even though the accessories may not otherwise be a good fit for the MUP because of price point, for example, or because the retailer has provided an unattractive image. In the end, associate selling allows the creation of virtual “end-caps” on the Web, an analog of the browse traffic in a retail store that obviously gets attracted to the end-caps. The end-caps are attractive because manufacturers pay large sums to place their products on them at hugely attractive prices to try to incite impulse buyers.

Referring to FIG. 3, the ordinarily-skilled practitioner will note that the MUP creator 303 constitutes one of the human touch points of the network merchandising system. The MUP creator 303 computes an indicator of fitness for the products based on factors such as image quality, existence of special offers such as discounts or free shipping, and so on, that it rolls up into a fitness ranking. Left to its own devices, the MUP creator 303 would just pick, for example, the 200,000 products with the highest rank. What the user is doing with the MUP creator 303 console is configuring the MUP creator so that it is forced to choose a certain fraction of the products from one category, brand, merchant, or another. So, for example, if the user were to tell the MUP creator to “just pick hats and shoes in a 1:1 ratio”, then the MUP creator would choose the 100 k most fit hats and the 100 k most fit shoes.

While the organization and filtering involved in creating the MUP is largely driven by automated logic and analysis, human factors also drive the process. For example, a human may take a position, for example, “I want to include every product from GAP in this repository, because I want to sell GAP (GAP, INC., San Francisco Calif.) products on this particular Web site.” Or, for example, someone may decide, “For this particular week, or for this day, I don't want to include anything from eBay (EBAY, INC. San Jose Calif.).” Such decisions may be seen to constitute MUP specifications. Thus, MUP specification is driven by a human being that determines the rules that control what should be contained in the MUP 304 for any given time period.

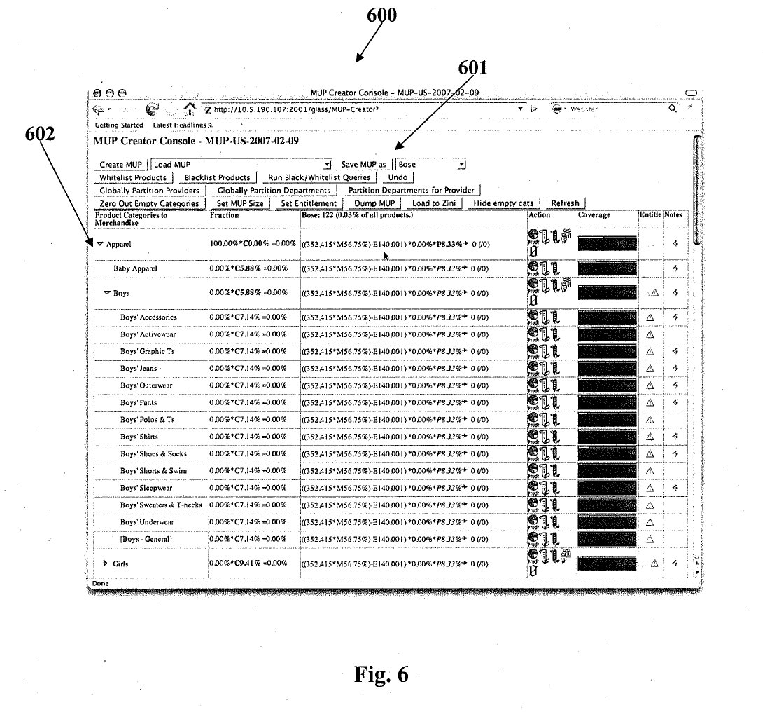

FIGS. 6-10 are a series of screenshots of a user interface to the MUP creator 303. FIG. 6 shows an initial screen 600 to the MUP creator console. The initial screen provides a plurality of controls 601 in the form of buttons and pull-down menus. By means of the controls, the user is able to access a variety of functions related to creation and management of the MUPs. These include:
create a MUP specification;
load a previously created MUP specification;
save and name a MUP specification;
whitelist products;
blacklist products;
run queries that determine membership in black/whitelists;
undo;
globally partition providers, i.e. specify what fraction of the MUP should be drawn from the product offers provided by each catalog provider;
globally partition departments, where departments refer to the category of product offer, shoes or TVs, for example;
partition departments for provider. In other words, specify the distribution across different product categories within the set of offers from a particular provider;
zero out empty categories;
set MUP size—the number of product offers that will be in the finished MUP;
set entitlement—the number of offers that are evenly distributed across all of the product categories;
dump MUP—use the MUP specification defined via this user interface to select an actual set of products from the aggregated catalogs and write them to a file;
load to ZINI, a parametric search engine that is used to browse and search the MUP;
hide empty categories; and
refresh.

Using the pull-down menu, the user is able to select from a listing of existing MUP specifications. By selecting a MUP specification from the pull-down list, the definition for that particular MUP is loaded into the console for viewing. Upon loading the definition, a table of data 602 appears. Initially, this table enables the operation “partition departments for provider”. A second pull-down menu also appears, providing a list of provider names, for example “BOSE,” as shown in FIG. 6, allowing the user to select the provider whose partition information is shown in the table.

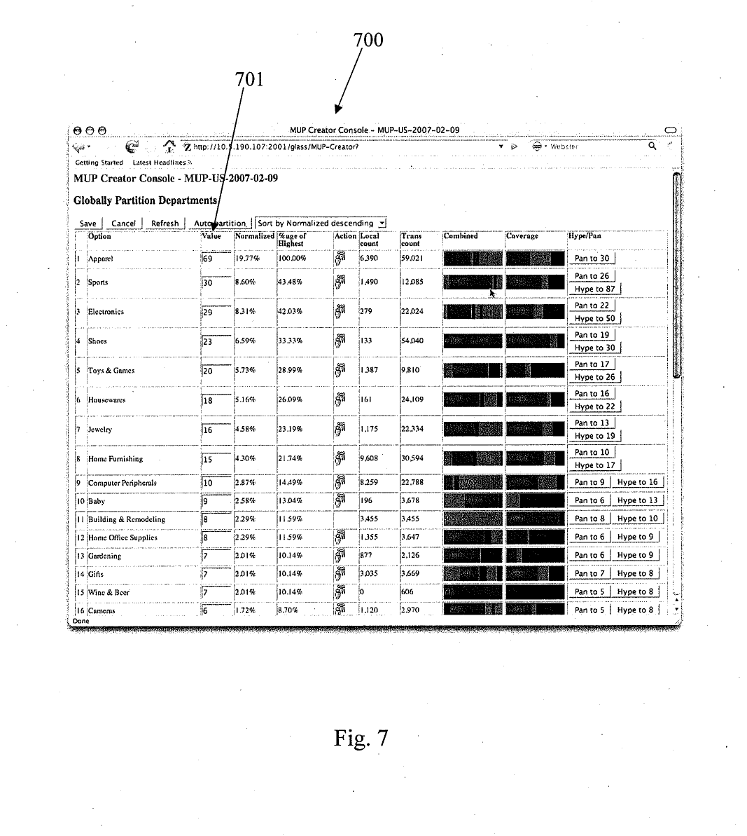

By selecting the button labeled ‘globally partition departments,’ the user is navigated to a second screen 700, as shown in FIG. 7. Again, a series of controls and a table of data are shown. The controls include:
save;
cancel;
refresh;
auto partition; and
a pull-down menu allowing the user to select from a variety of sort options.

Using the screen 700, the user is able to establish the percentage of products to be allocated for each product category. Additionally, the user can select the option to auto-partition, in which case, the system would automatically establish the partition among product categories. In one embodiment, automatic partitioning is according to a pre-determined algorithm. In a second embodiment, automatic partitioning is according to an adaptive algorithm. Pressing ‘save’ saves the partitioning information. Pressing ‘cancel’ returns the user to the initial screen without saving.

As shown on screen 700, the user sets the percentage of products to be allocated for each product category indirectly, by entering a value into the ‘value’ column 701. These values represent categories' relative shares of the total, which the system then totals up and converts to a percentage. As a shortcut for changing the relative importance of categories, the far right column, labeled Hype/Pan, provides buttons for adjusting the share values to computed values. The “Pan” button has the effect of moving a category down one level in the list, and the “Hype” button moves it up.

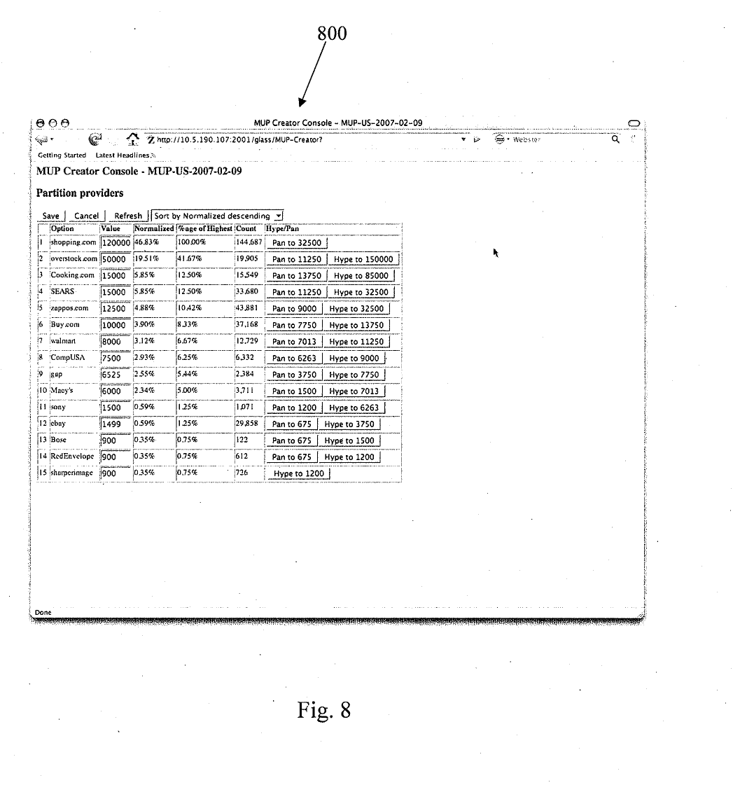

FIG. 8 shows a screen 800 from the MUP creator console that allows the user to partition the product mix in the MUP among catalog providers, or retailers. This corresponds to the “globally partition providers” button on screen 600.

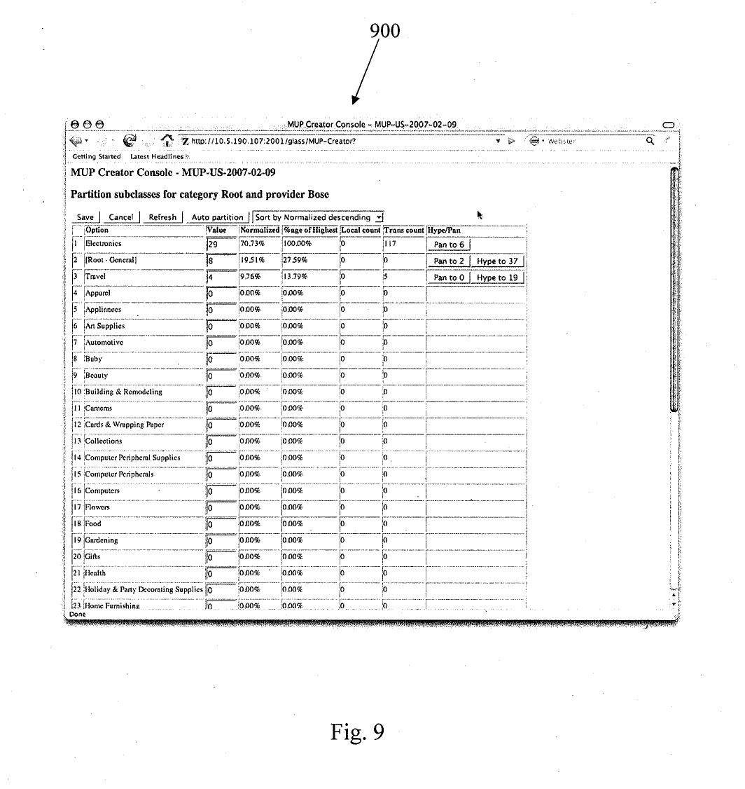

FIG. 9 shows a screen 900 from the MUP creator console that allows the user to partition the product mix for a particular provider, for example, “Bose.”

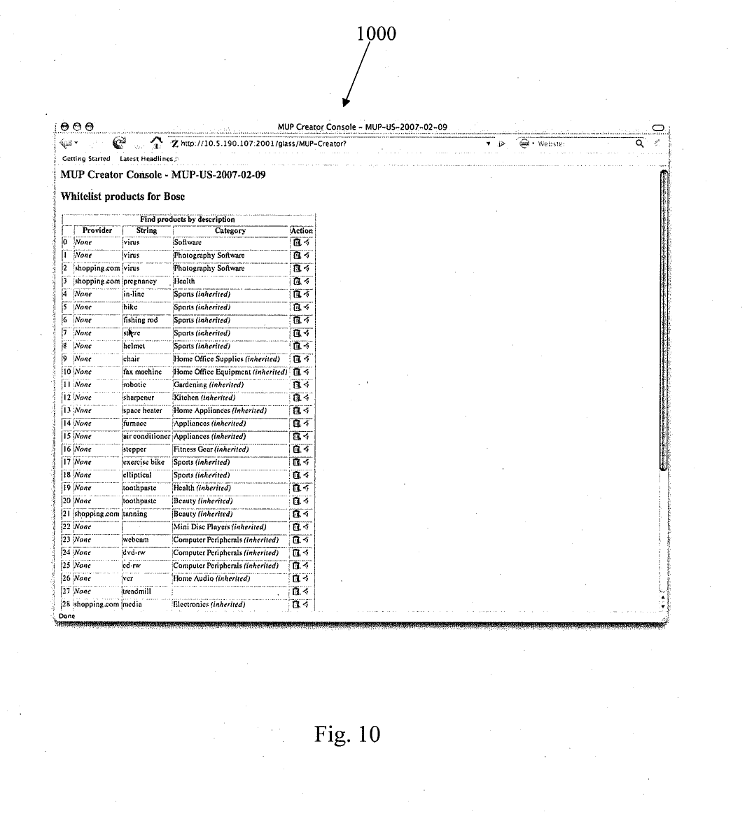

FIG. 10 shows a screen displaying a whitelist of products for a particular provider, for example, “BOSE (BOSE CORPORATION, Framingham Mass.).” The ordinarily-skilled practitioner will readily understand that a product whitelist includes products that are deemed acceptable according to some predetermined set of criteria and a product blacklist includes products that are deemed not acceptable according to some predetermined selection of criteria. As shown in FIG. 10, the whitelist shows providers and product categories that can be combined with product offers from the provider “BOSE” to be displayed to the user in an ad unit or widget, as described in greater detail below.

The output of the MUP creator is a MUP 304.

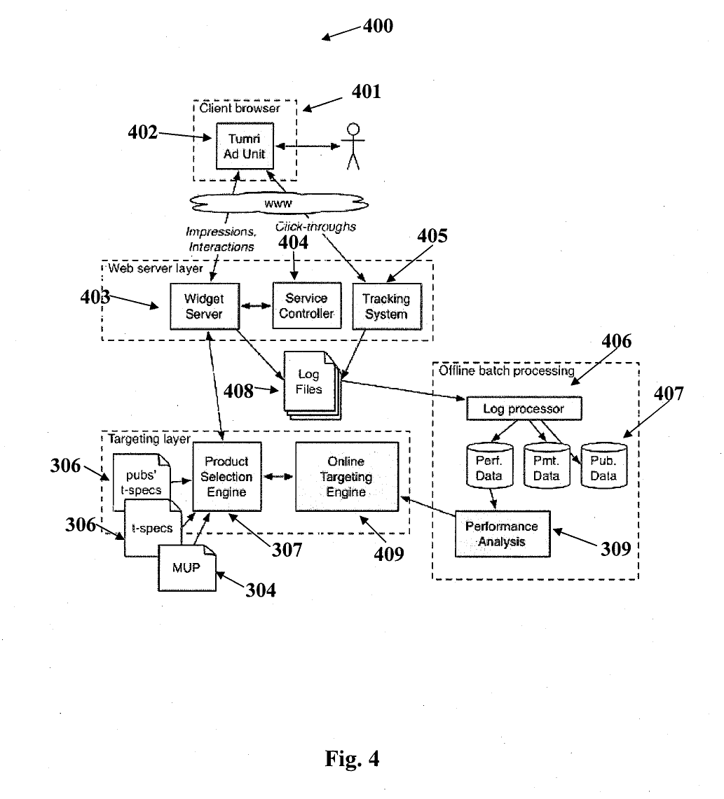

A targeting spec (t-spec) 306 is a query or algorithm description that selects products from the MUP. The purpose of the t-spec is to define what products are shown in a particular context. For example, if it is desired to show shoes on an ad on the “Manolo's shoe blog” site, then the t-spec for that site could be a query that returns shoes, or related products. As shown in FIG. 4, different parties may create t-specs. For example, using the publisher portal 500, content publishers can create t-specs. More will be said about the publisher portal. Additionally, users associated with the merchandising system may also create t-specs.

A targeting console 305, a second human touch point to the system, is a tool that allows a user to design, view and edit t-specs 306. This user is typically someone associated with the network merchandising system. The user interface used to specify a t-spec from the targeting console is functionally equivalent to the publisher portal's store builder 502, which is described in detail in another section. The additional functionality in the targeting console is a facility to indicate in which context(s) each t-spec should be used to select products. For example, in one embodiment, the context could be defined by the URL of the page that shows the ad unit. In other words, in the live service, the service controller 404 examines the URL of the incoming HTTP request, and maps it to the name of a t-spec that is associated with that URL. This t-spec name is then used to inform the product selection engine 307 which t-spec to use for selecting products for that particular impression.

The targeting console 305 may be seen as a configuration tool for the product selection engine 307. For example, a publisher may decide, “Okay, so on NBC affiliate stations from San Francisco, for the next three days I would like to promote football merchandise for the Colts versus the Bears,” which is, essentially, a merchandising campaign.

An automated engine or computer cannot readily discern the goal and automatically determine what steps to take to execute such a campaign. Some aspects can be picked up based on web page content. But a human being is actively involved in the process by saying that he or she wants to promote these sorts of products for this time period.

Thus, the targeting console 305 essentially generates such merchandising campaign specifications for test-marketing, or for product merchandising across the advertising inventory, knowing that there are ad slots to fill across different categories of virtual properties such as blogs, portals and product review sites. Accordingly, the t-spec 306 may be thought of as a marketing campaign.

A product selection engine 307 operates to work efficiently with queries into the MUP 304. It is a component that selects the product offers to be shown in the widget for a particular impression. The product selection engine 307 loads the MUP and the t-spec files into memory at startup time and executes and/or caches the results of executing the t-specs against the MUP 304.

At the end of the content pipeline 300, the content is ready and blessed for distribution across the web through the merchandizing network system.

### Live Service

The ordinarily-skilled practitioner will appreciate that the live service may be understood as the ad-serving infrastructure. The ad-serving infrastructure primarily works in the following manner: a publisher, or a web site owner, chooses to partner with the system sponsor and incorporate one or more ad units on the publisher's pages, which is accomplished by the introduction of an executable script into the source code for the page. The script can be either be statically incorporated into the page, or it can be served through the publisher's own advertising infrastructure.

After the script is placed on the page, when a user browses to a given web page, the service gets a hit. The appearance of the ad unit on the page is seamless, without any obvious indication to the user that the ad unit it is being served up by a third party.

The live service can also be characterized as (1) the merchandising of the MUP's product offers across the web and (2) the behavior of the ad unit when a user visits a web page on which a widget or ad unit is present. The live service allows the right sort of products to be selected and makes it possible to specify which criteria from the user's context can be leveraged to pick the right sort of products from the MUP.

Generally speaking, the client browser arrives at the service through the Internet cloud. A widget server serves up the ad units in the user's browser when the user accesses a page that embeds or calls an ad unit. The widget server also communicates with a service controller providing a testing infrastructure that makes it possible to perform testing of widget-interface manifestations, and targeting algorithms.

The ordinarily-skilled practitioner will recognize that the same widget, user-interface manifestation is unlikely to work all across the web, across all users and across all different types of site. However, it is impossible to know a priori what is optimal. The system includes the capability of performing A/B testing of feature A versus feature B, or widget type A versus that widget type B, or “enable animation” versus no—“don't enable animation.”

A second level of experimentation involves the different types of product set that are going to be tested. Users' interests change continually and their browse patterns keep changing, rendering such testing necessary.

Assessing the current interest level for a given product, or a given brand, or a given merchant in a given price range requires constant testing. The live service provides the infrastructure to try different mechanisms, analyzing user behavior and making inferences from which to evolve with the goal in mind of optimizing click-though and conversion rates.

The live service, in one embodiment, as shown in FIG. 4, may be seen to include several functional units or layers, each layer including several components, the several layers including a web server layer that includes components for serving dynamic ads; a targeting layer that supports the web server layer by dynamically choosing product offers to display to the user by means of the ad unit or widget 402 in the client browser; and an offline batch processing unit that processes log files 408 from the widget server 403 and the tracking system 405.

An end-user interacts with the system via a client device such as conventional web browser 401. Using the web browser, the end-user visits various publisher web sites, the pages of which include one or more ad units 402, a widget that runs in the user's browser 401. As will be described in greater detail below, the publisher, a business affiliate of the system sponsor, specifies the type of ad unit 402 to be displayed on the page. The ad unit 402 shows several product offers and provides basic interactivity, such as ‘search’ and ‘browse.’

In one implementation of the invention, the ad unit 402 is known as a CORNER STORE, and is a web-based object that transforms constrained ad spaces, conventionally occupied by banner ads, into interactive product merchandising browsers. In one embodiment, the dimensions of the ad units conform to IAB (Internet Advertising Bureau) standards.

An ad unit 402 incorporates one or more of the following capabilities and/or features:
incorporates a product search browser with parametric refinement in a highly constrained space within the internet browser window;
provides in-place updates of the product offers shown in the ad unit based on more refined searches selected by the user;
increases the number of product offers displayed to the user by using a categorization mechanism rendered in the form of a tree browser and or drop-down combo boxes;
rich media template based rendering using multimedia authoring technologies such as FLASH (ADOBE SYSTEMS, INC., San Jose Calif.), blending brand/corporate marketing with product merchandising; mouse-over driven drop-down of product offers from a brand logo rendered in an advertising space;
every click on a hyperlink found on the widget is a potential monetization event. Some examples are: merchant logos, brand logos directed to a retailer's online storefront, category links mapped to retailer store front.
space within the ad unit that can be used for display of call-to-action text, pricing and discount information, special offers from the merchant, thumbnail versions of product offer images, a large version of those images, a title for the widget, links to third-party review content, and other content associated with product merchandising

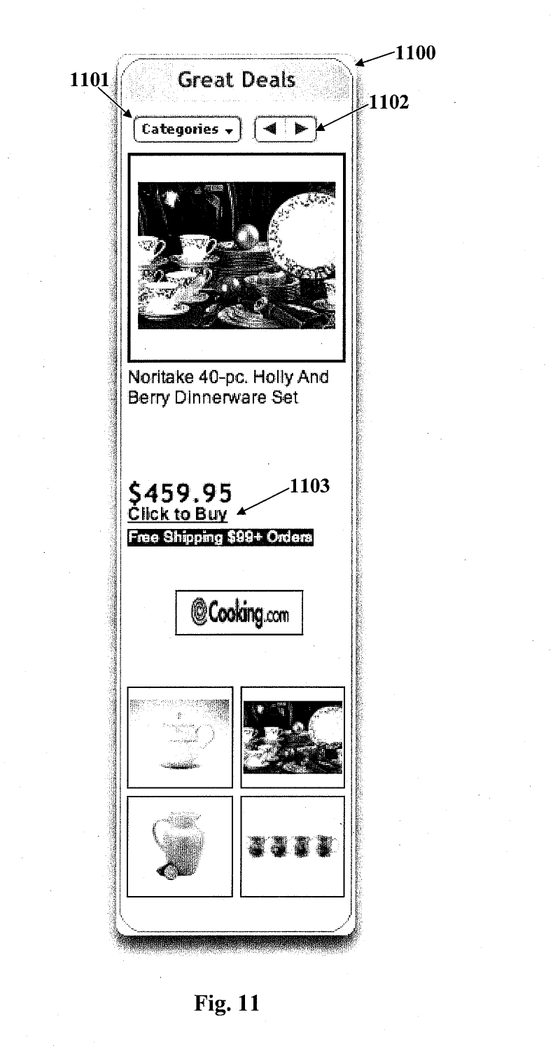

FIGS. 11-15 show various embodiments of a user interface to the ad unit or widget 402. Turning first to FIG. 11, shown is an implementation of the widget particularly adapted to fit into an advertising space on a web page intended for a “skyscraper” ad. As previously described, several of the various implementations of the ad unit preferably comply with standards established by the Internet Advertising Board (IAB). Shown is a screen shot of a user interface 1100 wherein a number of product offers are dynamically displayed to the user. A pull-down menu of product categories 1101 allows the user to select from among the categories of merchandise that has been selected for display to site visitors. Scroll arrows 1102 allow the user to scroll through the product offers for the category selected. As the user scrolls through the product offers, an image of the product is presented to the user. Additionally, thumbnail images of the various product offers for the category are presented in a separate region of the ad unit user interface. A link 1103 is provided that delivers the user to, for example, a purchase page of the retailer's site, should the user desire to take advantage of any of the product offers displayed.

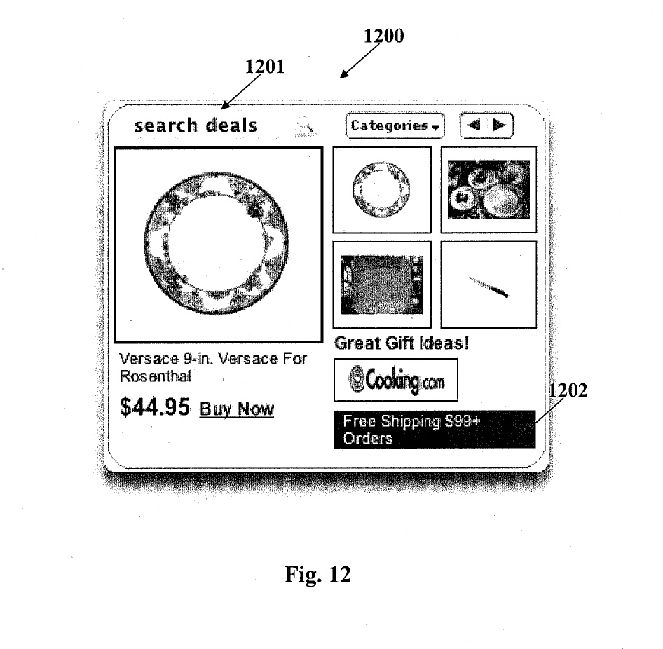

FIG. 12 shows an alternate implementation 1200 of a user interface to the ad unit 402. The embodiment of FIG. 12 provides a differently-dimensioned window, again compliant with IAB standards. The implementation of FIG. 12 includes all of the functional features of the implementation shown in FIG. 11. Additionally, a search feature 1201 is provided whereby the user is able to perform a focused keyword search of the product offers selected for display in this ad unit in addition to using the scroll arrows to browse the product offers. As shown in FIG. 12, the ad unit may include one or more announcements 1202 of purchase incentives, for example, as here, free shipping. Other incentives will be apparent to the ordinarily-skilled practitioner and are within the scope of the invention.

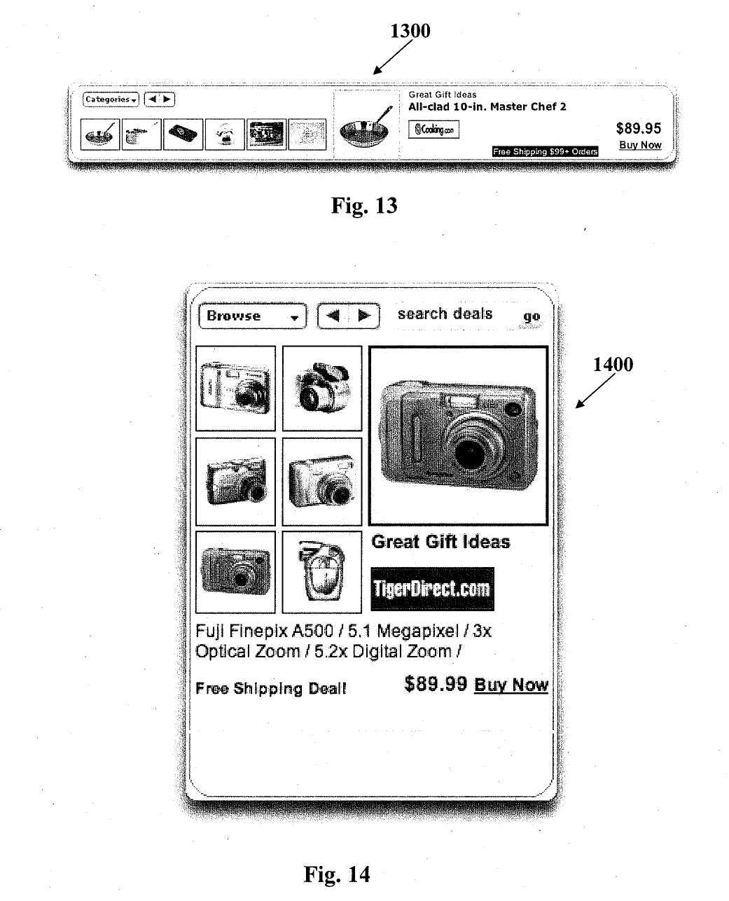

FIG. 13 shows an implementation 1300 of the ad unit that includes a user interface dimensioned to occupy a space suitable for a conventional leaderboard banner ad.

FIG. 14 shows a still further implementation 1400 of the ad unit.

Returning now to FIG. 4, the web server layer within the live service 400 may include a widget server 403, a service controller 404 and a tracking system 405. The widget server 403 is the component responsible for constructing the ad unit 402 and returning it to the client browser 401.

The service controller 404 is responsible for control of high-level services relating to the interaction of the widget with the client application. Thus, the service controller is responsible for choosing which services to implement for a given impression of the widget. For example, some impressions provide a ‘search’ function, while others do not, only permitting the user to browse through the product selections. Additionally, the service controller may determine whether or not a particular impression provides an animation capability. Also, by controlling which services are implemented for a particular impression, the service controller enables a testing infrastructure. For example, in order to compare targeting algorithms A and B, the service controller 404 executes a specification of the experiment. In this way, a publisher is given the capability of comparing t-spec A against t-spec B in production, before committing to one t-spec or the other for the majority of future impressions. It is the job of the service controller, for each ad impression, to select either t-spec A or t-spec B in accordance with the testing specification. The tracking system 405 functions to track click-though redirection and pixel integration with retailer online stores.

The targeting layer of the live service 400 may include the product selection engine 307 and an online targeting engine 409. As previously described, the product selection engine 307 selects the product offers to be shown in the ad unit 402 for a particular impression. The product selection engine 307 loads the MUP 304 and the t-spec files 306 into memory at startup time and executes and/or caches the t-specs 306 against the MUP 304.

The online targeting engine 409 is a dynamic targeting component that implements targeting changes due to the performance feedback. The targeting engine can modify or replace the t-spec that is used for a particular impression, based on both the analysis of the impression and its relation to the aggregated performance data as provided by the Performance Analysis component 309.

Targeting techniques may include:
user targeting, using, for example tracking cookies, or based on user metadata provided dynamically by the publisher;
page text targeting, based on analysis—both automated and manual—of the contents of the page that will contain the ad;
t-spec learning algorithms that incrementally tune the t-specs that are used for various publishers; and
location based targeting.

Additionally, retailers may be able to provide input that is not readily discernible from their product information catalogs. For example, they may have point-of-sale data or other types of data that they have accumulated from their own web sites, which can be incorporated into the feedback used for targeting.

As shown in FIG. 4, output from the widget server 403 and the tracking system 405 is written to a plurality of raw web server log files 408. The log files include, for example:
an impression log which records the context of each impression and what ad was served;
a widget event log which records user interactions with the service ad unit;
a click-through log which records click-throughs when a user is sent to a merchant, with the properties of the product clicked on; and
purchase logs, which record CPO (cost-per-order) transaction data downloaded from the retailers.

The offline batch processing layer 406 may include a log processor 406, one or more aggregated data tables 407 and a performance analysis component 309. The log processor loads the log files 408, analyzes and/or transforms them and produces the various aggregated data tables 407.
In one embodiment, the data tables may includes tables containing:
performance data—aggregated log data that is used to optimize the merchandising network's MUP and targeting specifications;
publisher data—aggregated log data that is used to generate reports that the publishers access through the publisher portal's performance reporting component 503.
payment data—aggregated log data that is required for computing billing of retailers and payment to publishers.

The performance analysis component 309, as above, analyzes the performance data in order to recommend settings, product white/black lists, or other input into the online targeting engine 409, as well as the MUP creator 303.

### Publisher Portal

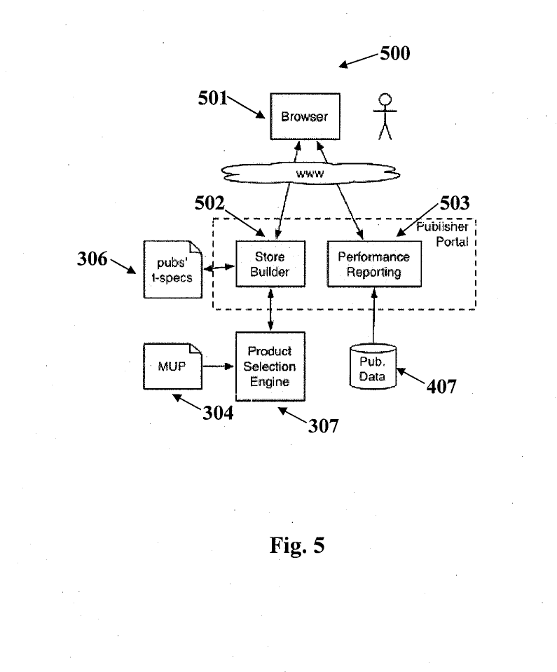

An additional major component of the merchandising network system is a publisher portal 500, as shown in FIG. 5. Primarily a service application, the publisher portal 500 provides services to publishers participating in the merchandising network and enables previously unaffiliated publishers to affiliate themselves with the network.

The way the portal works is for the publisher to come to a portal, register themselves as part of the network, and provide some information about the publisher's audience, about their content and/or about the pages that they typically write.

Once the publisher has registered, the publisher, using the tools provided in the publisher portal 500 is able to build an ad unit or widget—a “corner store,” and design a selection of product offers to be displayed from the ad unit integrated into their pages. The publisher portal 500 allows the publisher to control what appears inside the ad unit appearing on that publisher's pages.

Referring again to FIG. 5, shown is a schematic diagram of a publisher portal 500. In one embodiment, the publisher interacts with the publisher portal by means of a client application such as a conventional web browser 501.

The major component of the publisher portal 500 is the store builder 502. The store builder allows publishers to define the product offers they want to display in the ad unit 402 on their pages. The publishers can specify combinations of product categories, merchants, price ranges and keywords. The publishers then assign these t-specs to their stores and deploy the store scripts onto their pages. The scripts then access the system servers, at which time the publisher is live with the service. Ultimately, the output of this component is a set of publisher-authored t-specs 306 which are transferred into the product selection engine 307 running the live service 400.

Because it is used to develop t-specs 306, which are really queries or algorithms that can be used to select products from the MUP 304, the store builder 502 is connected directly to a product selection engine 307 that processes those queries or algorithms. That way the publisher users can see sample products selected by their t-specs as they are developing them. The store builder 502 includes at least an editor, store, and export facility for the t-specs 306, and uses the product selection engine 307 to execute the t-specs against the current production MUP 304.

The publisher portal 500 additionally includes a performance reporting component 503, which is preferably a reporting application that provides the publisher a plurality of different views of publisher data regarding the performance of corner stores on their pages. The reports are based on publisher data 407, performance data useful to publishers aggregated from the raw log files 408.

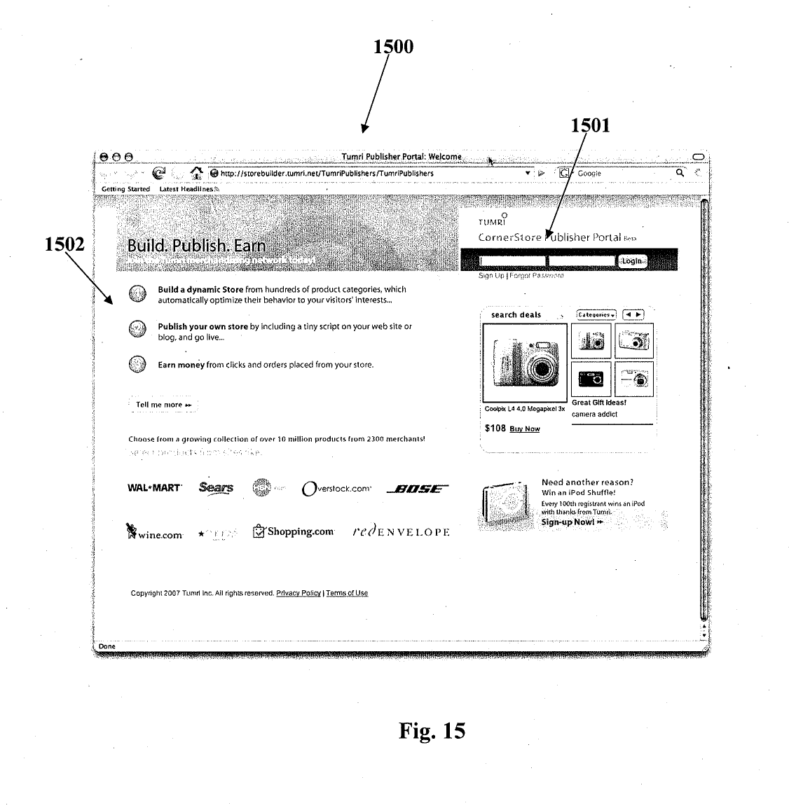

FIGS. 15-21 provide several views of the user interfaces to both the store builder 502 and the performance reporting component 503.

FIG. 15 provides a shot of a welcome screen 1500 to the publisher portal 500. In one embodiment, the welcome screen 1500 provides a link 1502 to a variety of information sources that explain the network merchandising system and the benefits associated with participation therein. Additionally, login controls 1501 for registered members and a link to a registration screen for publishers wishing to register are provided.

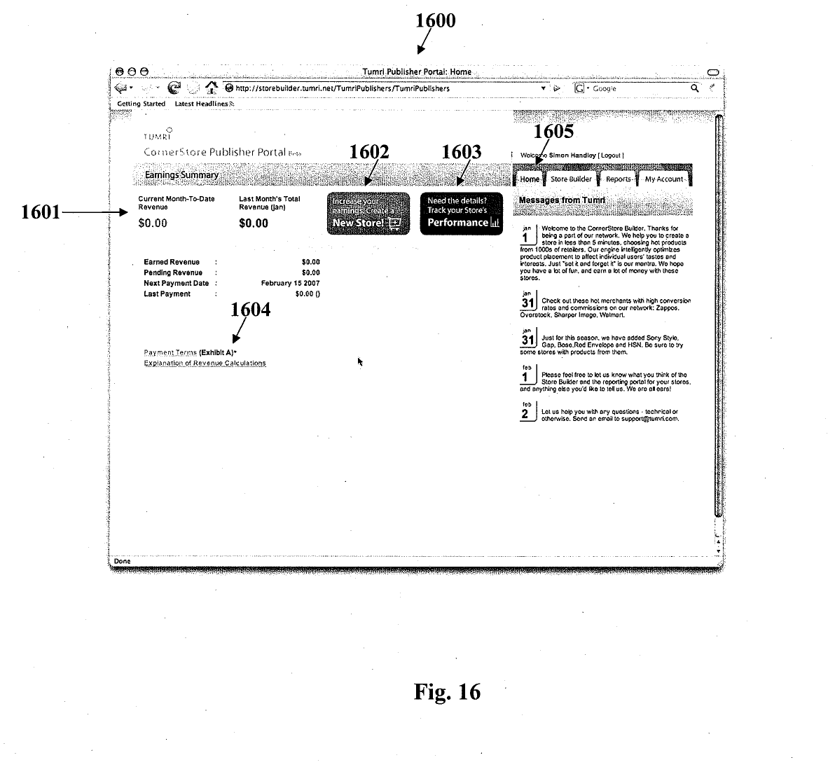

Upon logging in or successfully registering, the publisher is navigated to a home page 1600, as shown in FIG. 16, from which the various tools and functions of the publisher portal 500 may be accessed. A current earnings summary 1601, reflecting payments to the publisher by retailers for traffic to the retailer's site originating from the publisher's site is prominently displayed. The page 1600 may also include a link 1604 to a ‘payment terms’ document. A series of tabs is provided to remind the publisher which functional area of the publisher portal they are on. As shown in FIG. 16, the ‘home’ 605 tab is topmost on this page of the application. Additional tabs are ‘store builder,’ ‘reports,’ and ‘my account.’ Buttons 1602, 1603 are provided, selection of which navigates the publisher to the store builder 502 and the performance reporting component 503, respectively.

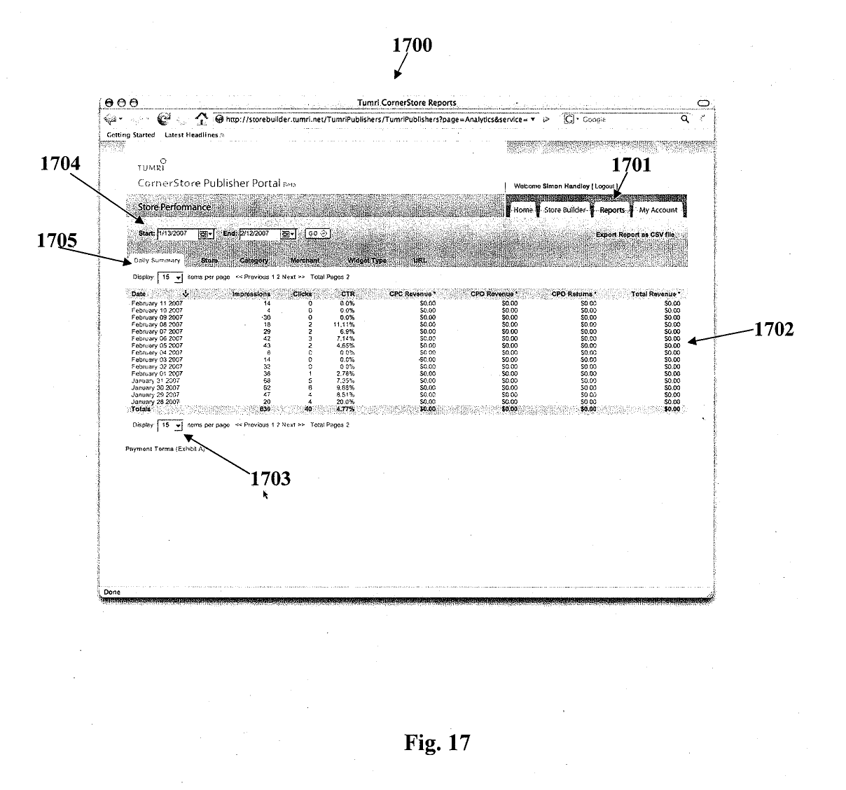

FIG. 17 shows a page 1700 from the performance reporting component, as indicated by the ‘reports’ tab 1701, which is shown in the topmost position. The initial report shown is a daily summary of store performance. In one embodiment the report comprises a data table 1702, wherein each row of the table summarizes one day's activity. The table may include columns for:
date;
number of impressions;
clicks;
the click-through rate (CTR) on that day (clicks divided by impressions);
cost-per-click revenue (CPC), or the amount of revenue earned through commissions paid for the clicks themselves;
cost-per-order revenue (CPO), or the amount of revenue earned through commissions paid for orders on the merchants' sites, that followed a click-through on a cornerstore ad unit;
cost-per-order returns; and
total revenue.

The ordinarily-skilled practitioner will readily understand that the above report format is provided to illustrate the principles of the invention, and is not intended to be limiting. Controls 1704 are provided by which the publisher may specify a data range for the report. Another control 1703 is provided by which the publisher can specify the number of records to be displayed per page.

A variety of reports and views are available from the performance reporting component 503, as indicated by the report tabs 1705, in addition to daily summary:
store, with performance aggregated by store definitions as specified in the store builder;
category, with performance aggregated for kinds of products;
merchant, with performance aggregated for the merchants selling the products;
widget type, with performance aggregated for different embodiments of the ad unit; and
URL, with performance aggregated for different publisher pages on which the ad units were shown.

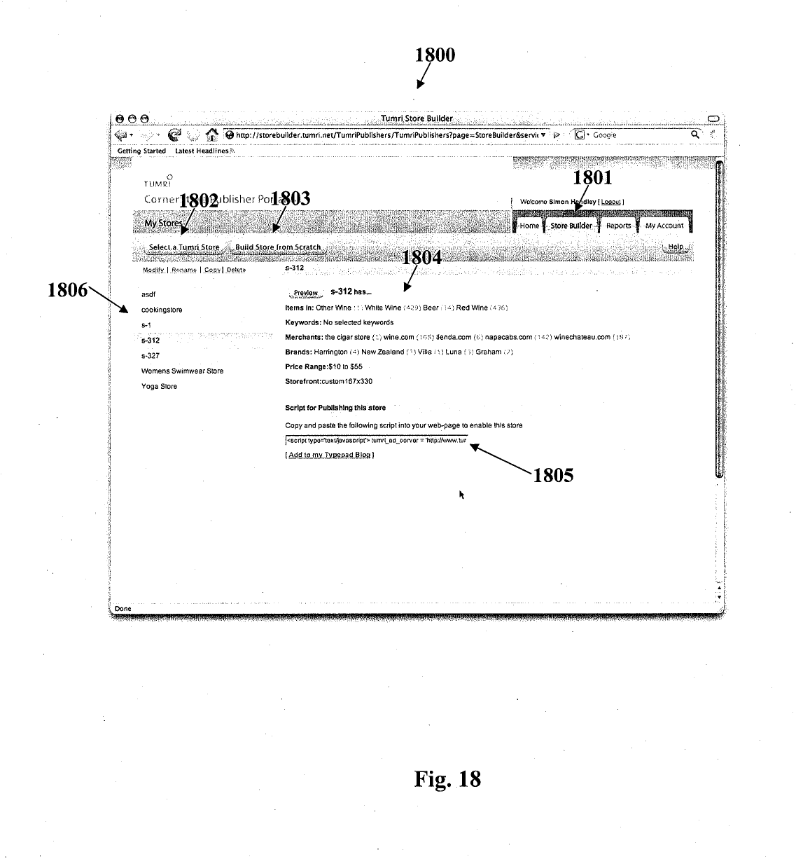

Referring to FIG. 18, shown is a page 1800 from the store builder 502 as indicated by the store builder tab 1801 in the topmost position. Buttons are provided either to select an existing store 1802 for browsing or editing, or to build a new store 1803. The page also shows a list of stores 1806 that the publisher has already defined. As shown in FIG. 18, store s-312 is selected. The parameters 1804 for the selected store are displayed. In one embodiment, the parameters provided are:
categories, listed with the heading ‘items in,’ which indicates the specific category constraints for the product selection query;
keywords, which constrain the store to have products matching the keywords;
merchants, which specifies from which internet merchants the product offers are selected;
brands, which constrains the selected product offers to a set of brands;
price range, which specifies the price constraints on selected product offers; and
store front, which specifies details about the appearance of the store.

Parametric ad content control is described in considerably more detail herein below.

The store builder 502 generates a script 1805, which, when inserted in the source code of the publisher's page, causes the widget server 403 to serve up an instance of the store each time that page is accessed by an end-user.

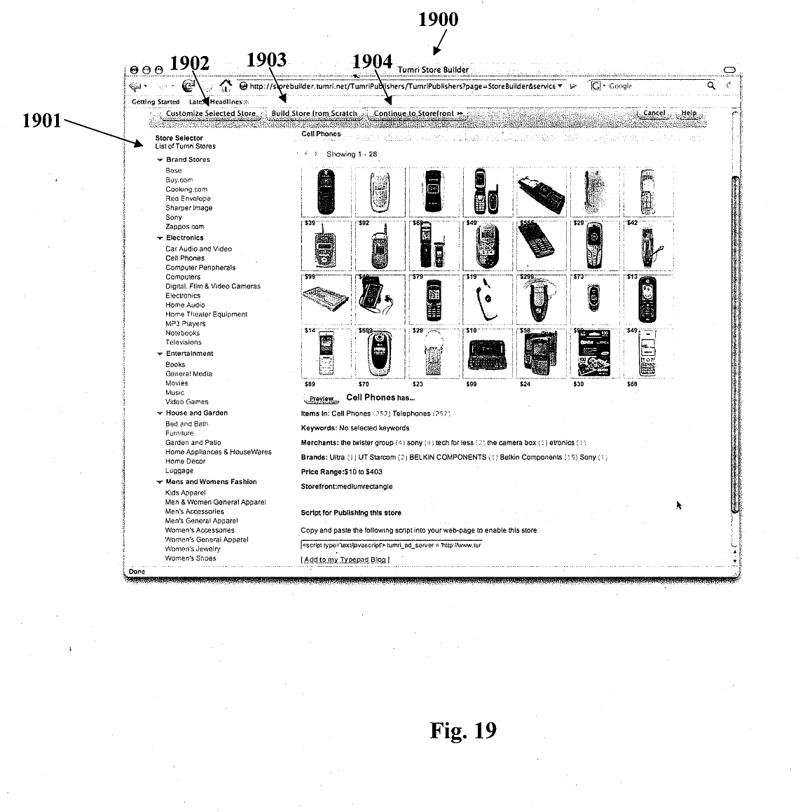

FIG. 19 shows another view 1900 of the store builder. On this screen, the publisher is constructing a new corner store, and specifically is selecting products to be placed in that store. To select the products, the publisher has the choice of using a pre-defined product set, modifying one of the pre-defined product sets, or designing a new product set from scratch. This view 1900 shows the publisher choosing from a list 1901 of pre-defined product sets. Buttons enable other options for defining a product set; the user can modify or customize a selected store 1902, or build a store from scratch 1903. Once the user is happy with the set of products, the next step is to continue to the storefront selection using button 1904. A menu of available stores is shown 1901, with the ‘cell phones’ store selected. As before, all of the store parameters are displayed. Additionally, images of a sample of the product offers available are displayed.

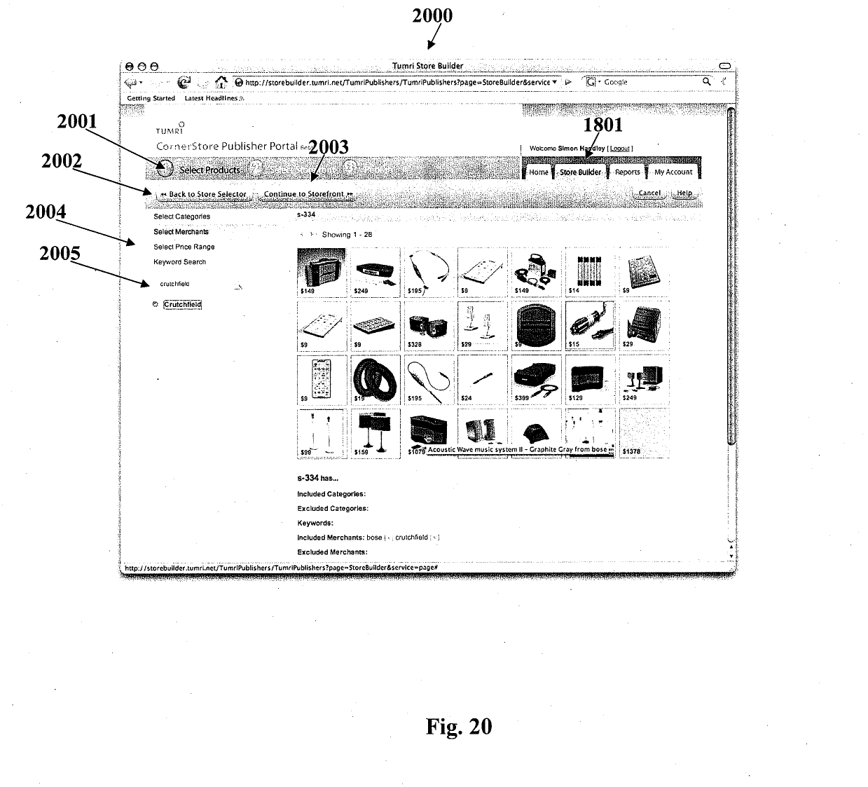

FIG. 20 shows a still further page 2000 from the store builder 502, by which the publisher builds a new store from scratch. The steps of the process as shown by the progress indicator 2001 include (1) select products; (2) select storefront; and (3) publish. As shown, the publisher is at the ‘select product’ stage. On this page, the publisher is either defining a product set from scratch, or customizing a pre-built one. Buttons provide the options of returning to the selection of pre-defined stores ‘back to store selector’ 2002, and continuing to the storefront selection ‘continue to storefront’ 2003. This page 2000 provides a number of editing controls for setting the constraints on the product set. Visible are the controls for categories, merchants, price range, and keywords 2004. In this case, the ‘select merchants’ control is active, and the editing area shows that the user has selected the merchant “Crutchfield” 2005. Ultimately, these controls enable the user to define the t-spec that will be used to select products for the store that is being built. One skilled in the art will realize that as other constraints or algorithms are enabled for t-spec definitions, that corresponding editing capabilities need to be added to this page.

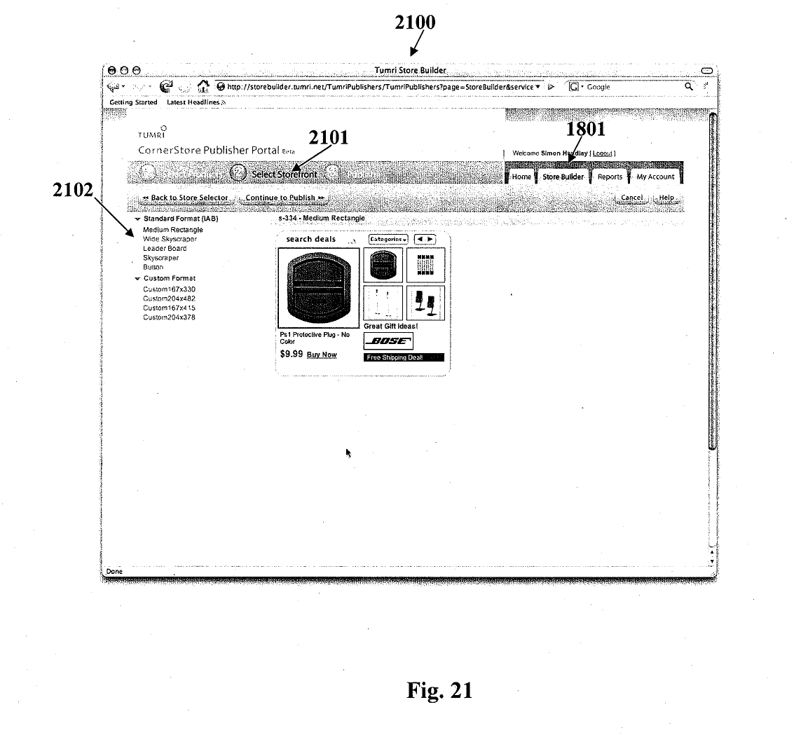

As shown in FIG. 21, the publisher has progressed to the ‘select storefront’ stage of the process. This stage allows the publisher to specify settings that control the visual look and feel of the store. These parameters can include color choices, text, titles, feature selection (e.g. search), and other parameters. The embodiment shown in FIG. 21 simply allows selection of the dimensions of the store, where the user is choosing between a list 2102 of standard IAB form factors as well as custom ones. A progress indicator 2101 confirms that the user is selecting the storefront. As the publisher selects storefronts, a trial ad unit is generated, based on the product selection and the storefront selected, so that the publisher can preview the store before going live. The final step of the process is publishing. Thus, a publisher, desiring to service an extremely finely-grained audience of users, can use the store builder 502 to create a store featuring products selected for the interests of this finely-segmented audience.

The ordinarily-skilled practitioner will understand that the foregoing description of the store builder and its user interface is meant to be illustrative of the principles of the invention and is not intended to be limiting. Other implementations of a store builder and a store builder interface that are faithful to the principles of the invention will occur to the ordinarily-skilled practitioner. All are within the scope of the invention.

For example, there may be a blogger with a blog devoted exclusively to information about APPLE products (APPLE COMPUTER, INC., Cupertino Calif.). This blogger, knowing his audience of a few thousand people very well, hypothetically knows that people who like APPLE products also tend to like to travel to Italy. It is not possible to achieve such fine-grained segmentation automatically. No software can actually discern, for example, that people who like Apple also like to travel to Italy. However, the system infrastructure enables this blogger to come to the publisher portal, and say, “Okay, show me all the books about travel to Italy and similar Italian-themed products that exist within this network merchandising inventory.”

This blogger—a publisher—can create a store which features things that are related to travel to Italy. Within the realm of pure contextual advertising, it would make no sense to display products related to travel to Italy on a site devoted to discussion of APPLE products. It does, however, make sense when the inherent behavioral aspects and the human intelligence are brought to design of the product mix.

Additionally, due to the adaptive capability of the infrastructure, the store is self-optimizing, updating the product offers in real time as performance data is analyzed and acted upon. For example, in one embodiment, products that perform well will be shown more often than products that don't. In this case, even after the publisher has selected products related to Italy, the network merchandising system will adapt to show mainly the most successful products related to Italy.

The corner store is also unlike a conventional advertising unit, which is typically intrusive, attempting to distract the user from what they are trying to do and attempting to elicit action on the part of the user. The invention recognizes that advertising is only useful to the extent that it is interesting, tasteful, not over-marketed, and, in the end, puts control in the hands of the publisher.

Networks are known that do one or more of: enabling a publisher to register and be a participant; and providing performance statistics regarding number of users arriving, product offers displayed, click-throughs, conversions, revenue share, and how the revenue is trending over time.

However, within the present system, the publisher is enabled to take the data and make it actionable. For example, a publisher may come to the network and let the automated product selection engine 307 define the product selection for a week. After this time, the publisher may discover that some categories are doing well and others are not. Furthermore, some merchants may be doing well while others are not. Advantageously, the publisher, by means of the present system can act on that knowledge, altering the mix of product offers and merchants that are being displayed in the corner store ad unit.

For example, a publisher might choose to completely eliminate any automated product-list retention, because he is confident that he knows exactly which products to be selling to his audience. With the store builder infrastructure the publisher can, in fact, make that happen—completely bypassing the automated engine. Or the publisher may recognize that the automated engine is effective to a certain extent, but he would like to add his own intelligence to the mix.

Furthermore, there are things that cannot be discerned by just looking at the page, for example, the knowledge of the blogger writing about APPLE products, that most of his audience is interested in travel to Italy. Such knowledge is also not obvious even from any other web traffic that could be analyzed. However, a publisher might have such knowledge because of their familiarity with the unique community that they address. Using the store builder infrastructure, the publisher is enabled to make this knowledge actionable.

### Parametric Ad Content Control

The system provides the publisher, on whose web pages the ads are displayed, detailed control over which ad content is displayed on the publisher's pages and the nature of the display. One purpose of such control is to satisfy the publisher's objectives—one should be far more satisfied with an ad service if he has nearly the same degree of editorial control over the ad content as he does over the rest of the content. More importantly, such editorial control allows the publisher to attempt to maximize the return on his or her advertising space.

The content selection is the more important aspect of the publisher's control. The system selects offers for display—products for placement—based on a parametric search over an integrated catalog of product offerings. A fully structured representation of the items in the catalog includes product characteristics, such as category, category-specific attributes, and price, as well as demographic information, age and gender, for example. The publisher can constrain the search for products by adding his own parameters to the ones used by the system's ad placement methodology. Examples of what the publisher is permitted to specify include:
limiting the type of goods to be advertised—products to be placed—on the site to a particular category, e.g. sporting goods or cosmetics;
limiting the advertising so that it targets a particular demographic, e.g. adult women, or upper-income; and
using the parametric catalog search to select a particular roster of product offers that the publisher would like advertised on his pages.

An important aspect of the publisher control of the ad content is that the system supports highly dynamic settings. That is, the system allows the publisher to adjust settings on a day-to-day basis, if desired. In addition, the parametric catalog search engine allows display of sample product offerings to the publisher as he experiments with settings, giving real-time feedback for the selection process.

Conventional online merchandising systems do not allow the publisher much control over the manner in which products are displayed, failing to provide any degree of fine-grained control of arbitrary parameters. Additionally, individual product offerings are conventionally found on product review sites or price comparison sites, but this functionality stands alone, and is not generally applied to a targeting engine that considers the site content and the user.

Unlike such conventional systems, the present system allows the publisher to control the manner in which product offerings are displayed in the same dynamic way that he can control product selection. The system allows the publisher to select from a set of ad units having settings such as “show pictures,” “collapse into categories,” “refine search in widget,” “click through to refined search page.”

### Ad Personalization

The system additionally has an adaptive capability that allows content placed in the internet ad spaces to be tailored to the individual user who is viewing it. Such personalization capability is dispersible across the web, applying in every case where the present system is serving ads. Conventional systems are limited to site-specific functionality, either for a particular merchant or an aggregator.

Personalization can be provided automatically or manually. In either case, the user is tracked, for example, using cookie technology. Whether the user is reading a news site or a blog, or some other type of content, the ad content in the margin is personalized to the user.

For automatic personalization, the system obtains the needed data through user tracking. The product-specific nature of the ads being served allows the system to track, for each user, what offers the user has been exposed to and how the user responded. Conventional advertisers, because they lack information about the ads that they display and because the bulk of ads are not for specific offers, cannot achieve such a fine-grained record of the user's interests—at least in terms of which ads they click through on and which they do not. The fine-grained record also allows application of any number of optimization techniques to improve future ad targeting.

For manual personalization, the user is given an option to set some demographic data the affects the ads served, e.g. gender or zip code. Conventionally, such demographic information has not been applied by a merchandising network before, spreading the personalization across many publisher sites.

### Dynamic and Adaptive Optimization of Internet Product Placement

Targeted product placement in online network merchandising ad units involves at least the following key aspects for its effectiveness:
relevance of products placed to pique the user's interest;
real-time optimization of key metrics that yield the best results for all constituents: publishers, system sponsor and retailer;
ability to handle large volumes of advertising inventory and its usage to leverage the network effect of such placement.

The system approaches the problem of optimizing internet product placement as:
a multi-objective assignment problem that accomplishes the assignment of products to network spaces;
feedback control system logic incorporated into the mode to progressively learn and alter the behavior of placement choices in an automated manner;
an ability to perform assignment at the scale demanded of the engine.

### Testing and Analytics

testing framework that allows direct comparison between different product selection techniques.
A-B comparisons in otherwise identical streams of impressions, controlling for whatever variables are necessary;
design experiments that will yield statistically conclusive results.
Logging and data analysis capabilities necessary to interpret those results readily. As previously described, the components for accomplishing such optimization are found within the live service 400, for example the service controller 404, log files 408, log processor 406, performance data 407 and the performance analysis component 309.

### Optimizing Via Context

Every ad unit impression comes with its unique context. While this term is frequently used to refer merely to the other content that appears together with the ad unit on a web page, there are many other aspects of an impression's context. Within the ad-serving infrastructure, it is possible to determine the user's context. For example, from the HTTP request one can deduce, for example, what URL the user is coming from, the URL the user is currently viewing, or the geographic location of the user, determined from an IP address that is mapped to a zip code or other geo-location specifier.

Furthermore, considerable information about the user can be obtained through an analysis of log files 408. If the user has been seen elsewhere on participating sites within the merchandising network, it is possible to do a significant amount of analysis based on the user's browse patterns: what else have they been interested in, in the past?

Also, much information can be obtained by analyzing similarity between users. For example, if two users visit the same page, then there is some level of similarity between their levels of interest, especially deeper within the path structure, or the site structure, of a given Web site. For example, if a pair of users is at the homepage of the New York Times, there is not a whole lot that can be said in terms of commonality between the two. However, if the pair is in the New York Times Arts & Entertainment, or shows in New York, or a specific page related to a specific show, or a review of a specific show, it is a reliable indicator of some similarity of interest between the two users.

Being able to track visit patterns and analyze user behavior across the network gives the ability to target products in the best possible way.

Various aspects of the context on which optimization is based include:
The web page that contains the offer:
   page content, for example headings or meta-tags;
   page intent, for example search, news, entertainment or reviews;
   demographic data, such as characteristics of the page audience;
The user who is viewing the offer:
   individual demographic and/or psychographic profile;
   history, for example pages viewed or responses to previous ad unit impressions;
   intent, for example search terms in referrer URL, or deduced from history;
   user location.
time factors:
   time of year and approaching holiday or activity; and
   time of day, day of week.

### Optimizing Via History

In order to optimize via history effectively, the system provides the capability of keeping careful activity logs and then provides strong feedback loops from the logs into the production selection process.

Among the areas where the feedback loops affect the system's behavior are:
MUP (merchandisable universe of products) construction, for example: keep best-sellers in the MUP, learn to categorize new products based on performance of similar products, provide proper product/category testing techniques;
targeting constraints for realms or users; provide targeting data to aid setting those parameters;
product selection for a widget impression, for example: favor more lucrative products, conduct CPA (cost per acquisition) auctions for impressions, test products to learn performance;

### Optimizing Via Product Attributes

Selection optimization can be based, at least in part, on a plurality of product attributes such as price point, value, usability and prestige. Other attributes will occur to the ordinarily-skilled practitioner and are within the scope of the invention. It will be appreciated that optimizing via product attributes links closely with demographic targeting.

### Optimizing Product Combinations

Combinations of products presented in a widget may affect click-through and conversion rates. A number of approaches may be applied to optimization of product combinations: comparing a jumble vs. a category-sorted approach, engineering the set that appears on the first screen, or particular combinations of similar products to be compared on the widget.

### Enhanced Brand Advertising

The network merchandising system also includes an advertising widget that provides the capability of providing brand advertising with specific product offers on the web. Brand advertising is important to suppliers having brands, but the specific product offers provided by the present system are more effective in terms of driving actual sales. It is therefore desirable to combine the two approaches within a single object.

Initially, the brand-advertising widget appears as a brand advertisement in a normal space on a publisher's web site, for example, a banner or skyscraper ad. However the brand-advertising widget provides a way to mix in specific product offerings, for example:
on mouse-over, the ad changes to a set of specific product offers. Additional effects may be provided, such as the ad expanding as the product offers are displayed;
product offers are displayed, or scroll past, in a corner or margin of the brand advertisement.

Different options are available for click-through behavior:
go to the purchase page on the advertiser's web site;
if the advertiser is a manufacturer that wishes to drive traffic to selected retail partners, then click-through traffic is sent to purchase pages on the partner's sites;
go to an intermediate site that aggregates buying opportunities for the particular product.

### Cross-Session Purchase Tracking

The network merchandising system also provides the capability of staying engaged in a purchase transaction beyond the impulse-buy period—the initial session where the user clicks through an ad and visits the merchant web site. Merchants typically prefer to pay on a commission basis, instead of per impression or per click. However, conventionally, it is only possible to perform the tracking necessary to earn a commission for a single session. Thus, if a user clicks through a widget and visits a merchant, but then comes back and makes the purchase the next day, the referring party does not get paid.

One solution to this problem is to increase the opportunity and incentive for the consumer to make the purchase on a browser session that originated with the ad unit. Some elements of this include:
offer cash back on purchases made after clicking through an ad unit. This may involve
   collect the contact information for the consumer, preferably only once;
   adding an identifying mark to the browser screen to confirm that purchases made qualify for discount;
   periodically pay the rebates.
collect ads—product offers—that have interested a particular consumer on a personalized destination site. The user then visits the site, reviews the ads, and clicks through to make a discounted purchase.

### Automated Product Marketing Campaign Generators Driven by Semantic Analysis of Catalog Content

The network merchandising system also enables creation of numerous semantically driven merchandising campaigns. Leveraging the semantic content processing engine that is embedded in the service, the system suggests campaigns that are based on the following parameters:
gender and age;
location;
categorization inherent in products and services;
price;
availability;
deeper attributes that are extracted from processing—that are specific to each category; and
calendar.

Conventionally, launching a campaign involves one or more activities that may include:
a user interface that enables careful crafting of product assignments to a campaign;
a rule that is encoded using a proprietary language that describes the campaign;
explicit delineation of targeting criteria such as gender, income or age;
campaign scheduling and running logic that needs to be maintained;
revisitation of the campaign at frequent intervals to preview, launch or otherwise control a given merchandising campaign
little, if any automated cross-sell/up-sell being part of campaign management.

The system provides a novel automated generation, selection and feedback-oriented control system loop that can help the merchandiser quickly look at a set of merchandising campaigns that he or she can preview and launch with minimal knowledge of the system internals. Such capability is enabled by the catalog-processing engine, which maps product descriptions in the merchant's catalog into the system's product ontology.

Thus, the system enables automatic generation of merchandising campaigns categorized, for example, as “Seasonal apparel promotion for women,” “kids electronic toys from MATTEL,” “gift ideas for a graduating girl student,” “back-to-school supplies,” and so on. Each campaign is suggested after a thorough analysis of, the catalogs for each retailer with a short list of meta question that are asked of the marketing manager such as:
Who are you selling to?
When do you want to sell?
How do you want to sell?
What are your overall/category-driven revenue goals?

At the end of this answer solicitation, the system suggests a set of campaigns that can then be approved for launch after a real-time preview on target sites.

### Proliferation of In-Store and Resident Channel Merchandising Using Contextual, Personalized Marketing Principles

Retailing in both off-line and on-line store space relies on practices that have evolved over several decades of discerning consumer behavior, supply chain interactions and event-driven personalized marketing campaigns.

Such merchandising practices may include:
organization of store space based on demographics, e.g. men's and women's apparel sections;
organizing store space by product category;
branded product aggregation on floor space, e.g. a POLO store, HP office automation product desk;
within departments and aisles, product promotion employs several approaches that include:
   seasonal promotions;
   product popularity promotions;
   stock and inventory driven promotions;
   marketing budget contributions from branded manufacturers;
   product promotion in high-traffic areas, e.g. end-caps and eye-level;
   discount driven merchandising; and
   cross-selling and up-selling by placing related categories next to each other e.g. mobile phones and accessories; plants and containers.

Extending these well-known paradigms of product merchandising to the web in an automated, scalable manner is the substance of the automated merchandising network system.

The network merchandising system uses its ability to understand product and service catalogs with respect to their semantic meaning and thereby maps it to merchandiser intent in a completely automated fashion. The technology required to handle millions of real-time updates to the catalogs and thereby affect semantic merchandising campaigns is the unique value proposition of the service. The service applies network optimization algorithms to capitalize on the relative benefits of placement of products on destination sites'advertising real estate.

One-on-one marketing in these ad spaces is made possible by discerning:
context from the user's visit to a given site;
specific interaction of the user's navigational choices;
location obtained from the IP address; and
time of day and calendar driven context.
past behavior of this and other similar user being used to market products.

The network merchandising system links product marketing and advertising on the web in a way that enables the proliferation of the internet as a continually-expanding sales channel.

The automated network merchandising system provides a platform for a pay-for-performance business model wherein sales transactions occur as a result of the marketing and merchandising activities occurring around the web in an automated, scaled fashion, wherein users around the web click on products and purchase them.

In this automated test-marketing process, there are also human touch points. In fact, test marketing starts out with the human input, where a human being, such as a merchandising manager or a marketing manager decides to initiate a particular campaign.

A marketing manager or a merchandising manager segments their consumer base and decides, for example, that they would like to market a handbag to high net worth individuals that engage in a lot of international travel. At the outset of the campaign, in order for it to be successful, it must be determined where high-net-worth individuals are to be found.

High-net-worth individuals watch certain kinds of TV programs, subscribe to certain kinds of magazines and they probably travel a fair bit. Therefore, the goal of selling to this kind of buyer translates to a set of properties or physical locations around the world where they choose to test market.

However, on the web it is a lot harder to do, because the number of channels is infinite. It is also almost impossible to determine what such a test campaign would look like. Most advertising infrastructure does not allow for such an ad campaign to be run.

On the web, consumers constantly leave clues to their interests. For instance, if they're starting out at Google, and they enter “travel to Greece” as a search term, it is a fairly solid indication of the fact that the person is interested in travel, leaving a clue as to their interests. It is also true that trying to market to anybody other than those that are interested in travel abroad is unnecessary and wasteful on the Web.

While large advertisers on the web attempt to segment their prospective customers as they do in off-line merchandising, they lack the ability to segment consumers in the fine-grained manner required to successfully merchandise and market on the web.

The network merchandising system has the capability to do a fine-grained analysis of user behavior and apply that intelligence to map products to users arriving at a given Web page. Accordingly, with such fine-grained data, it may be possible to find those highest-converting users on a blog page somewhere, for example, because this blog talks about traveling to Greece. Conventionally, it is impossible for a marketer to find such a channel, because such a community may not number more than one hundred users. They may, however, be the most prominent hundred users for the particular retailer.

The system enables such test marketing to happen in a much more semantically meaningful manner on the Web allowing levels of demographic, associative, and psychographic targeting and even some location or location-enabled targeting.

Thus, a deep, fine-grained analysis of user behavior, page content, and product attributes greatly increases the chances of segmenting at such a fine level.

For example, a merchandiser may be trying to reach 18- to 25-year-olds that have been looking for MP3 players, regardless of where they may be. They could be going to MYSPACE (MYSPACE, INC., Los Angeles Calif.) or SHOPPING.COM (SHOPPING.COM, INC., Brisbane Calif.) or NBC to check out information on MP3 players. But this has almost nothing to do with the page itself. It has more to do with behavior and patterns.

The system allows analysis of those behaviors and patterns—marketing to such behaviors and patterns requires that the merchandiser be able to analyze the content in a fine-grained manner, understanding the latent semantics associated with a given product. For example, the fact that COACH (COACH, INC., New York N.Y.) is a high-end brand versus OVERSTOCK.COM (OVERSTOCK.COM, INC., Salt Lake City Utah) is a fairly important distinction that is nevertheless commonly missed. Advantageously, the invention allows the merchandiser to analyze process and organize content in such manner.

Accordingly, the invention allows a merchandiser to translate in-store merchandising methods to external channels on the web in a manner that scales and, at the same time, is highly-personalized to the user due to the fine-grained segmentation of the user base that becomes possible when applying the principles of the invention.

Using physical retail stores as examples, one may consider the manner is which apparel is merchandized in a high-end department store. One first notices that apparel is very clearly segmented by gender. Beyond this, there is a careful selection of the kind of merchandise presented to the shopper, first in terms of curb appeal in order to attract the consumer's attention so that they will enter the store or the aisle. After entering an aisle, the consumer may encounter carefully crafted displays providing ensembles of products, for example this top, this skirt, this scarf, these shoes, and these sunglasses on a mannequin. And these are mechanisms that they've used all along.

Another example would be a printer desk in a computer store. The analysis has been done by the merchandiser carefully in terms of when a person comes to buy a printer. The customer will clearly need associated accessories ink or toner cartridges, paper, other related peripherals, and so on. It is also usually preferable to give more choice rather than less. Thus, on a printer desk one would find more than one printer that displayed, allowing for price comparison and feature comparison in one shot.

And there also there is the notion of cross-selling and up-selling the customer may have gone to the computer store intending to buy a $200 printer with basic functionality, but then purchased something more expensive that allowed him to print photos, send faxes and scan documents.

The point is that the above practices have been in use by merchandisers in conventional channels over time. A merchandiser is always thinking in terms of increasing the gross merchandise sales per average customer. The practices are well understood and they are supported by analyses of point-of-sale data.

The invention provides the capability of taking a retailer's product catalog and figuring out a way to translate conventional in-store merchandising to the web and causing it to proliferate across the web.

The invention recognizes that it is possible to leverage existing online advertising real estate using the targeting technology and methodology of the invention to analyze traffic, user behavior, content to merchandise the right set of products to the right set of users using advertising spaces and, at the same time, leverage whatever merchandising practices and rules the merchandiser employs. For example, no semantic analysis would yield the fact that beer and diapers are related to each other in terms of making a sale. However, if a merchandiser, having analyzed it, believes that there is an association, the invention allows the merchandiser to implement it.

A retailer, through automation and scaling can bring their in-store merchandising practices to external channels across the web to millions of ad slots, where it's being exposed to millions of users. Not only that, but the merchandiser can expose their merchandising rules and practices to the disparate user base across the web in a highly personalized manner in a pure pay-for-performance model.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A merchandising network system comprising:
a component for analyzing and organizing a body of product offers aggregated from a plurality of sources;
a component for filtering said body of product offers to produce a merchandisable universe of products (MUP);
a tool for designing an advertising unit for inclusion on a web page by an owner of said web page, said tool including means for authoring targeting specifications that describe one or more selections of product offers targeted to an audience for said web page; and
an ad-serving infrastructure operative to serve up an impression of said advertising unit for display to each visitor to said web page, wherein each impression displays at least one product offer targeted to a corresponding visitor based on said targeting specification, context of said impression, network performance history and product attributes.

2. The system of claim 1, wherein said component for semantically analyzing and organizing a body of product offers aggregated from a plurality of sources comprises a catalog processor, wherein said catalog processor is operative to load and analyze catalogs from a plurality of sources, said catalog process further operative support automated and manual quality assurance (QA) processes and to serve as a parametric query engine for said body of product offers.

3. The system of claim 1, further comprising a catalog store, said catalog store comprising an archive of catalogs and associated product offers.

4. The system of claim 1, wherein said component for filtering said body of product offers to produce a merchandisable universe of products (MUP) comprises a MUP creator, wherein said MUP creator is operative to choose product offers that comprise the MUP according to any of:
human input by means of an operator interface wherein said operator specifies characteristics of the MUP;
analysis of product offers, associated metadata and associated images; and
past performance of any of products, product categories and sources.

5. The system of claim 1, further comprising a performance analysis component, said performance analysis component operative to:
analyze performance data derived aggregated from log data; and
recommend MUP settings to a MUP creator.

6. The system of claim 1, further comprising a targeting console component, wherein said targeting console component is operative to accept human input by means of an operator interface to:
define targeting specifications that select, by means of query or algorithm, product offers to be displayed in particular ad contexts; and
specify the context, based on user characteristics, characteristics of the web page that will contain the ad unit, user's geographic location, and time at which the ad is shown, in which particular targeting specifications will be used.

7. The system of claim 1, further comprising a product selection engine operative to execute queries against the MUP using said targeting specifications.

8. The system of claim 1, wherein said ad-serving infrastructure comprises:
a widget server;
a service controller;
a tracking system;
an online targeting engine; and
a log processor.

9. The system of claim 8, wherein said widget server comprises a web server, said widget server operative to construct the advertising unit and serve it up for display by means of a client application.

10. The system of claim 8, wherein said advertising unit is deployed to said web page by means of a client-side script embedded in the source code of said web page.

11. The system of claim 8, wherein said service controller controls interactions of said advertising unit with the client application, controlling implementation of high-level services and providing a testing infrastructure.

12. The system of claim 8, wherein said tracking system is operative to track click-though redirection and pixel integration with retailer online stores.

13. The system of claim 8, wherein said online targeting engine is operative to analyze context of an impression and produce any of targeted product offers and queries for a product selection engine based on said analysis, wherein targeting includes any of:
analyzing any of user history derived from a tracking cookie, metadata provided dynamically by a publisher and demographic information provided by said user;
analysis of the contents of the page that will contain the ad unit;
targeting specification learning algorithms that incrementally tune targeting specifications;
location-based targeting; and
targeting based on retailer-supplied data.

14. The system of claim 8, wherein said log processor is operative to process server data from log files generated by said widget server and said tracking system, wherein said log files include any of:
an impression log that records any of context of each impression, which advertising unit was served, parameters that determine the configuration or behavior of the advertising unit, and which product offers were shown in the advertising unit;
a widget event log that records user interactions with the advertising unit;
a click-through log that records click-throughs when a user is sent to a merchant and the attributes of the product clicked-on; and
purchase logs that record CPO (cost-per-order) data downloaded from the retailers.

15. The system of claim 8, wherein said log file data is aggregated into one or more of:
performance data;
payment data; and
publisher data.

16. The system of claim 1, wherein said tool for designing an advertising unit comprises a publisher portal, said publisher portal comprising;
a registration component wherein publishers register to affiliate themselves with the network;
a store builder; and
a performance reporting component;
wherein publishers interact with said publisher portal by means of a client application.

17. The system of claim 16, wherein said store builder comprises:
means for defining product offers to be displayed in said advertising unit, wherein defining a product offer comprises specifying one or more combination of product categories, merchants, price ranges and key words, wherein defining said product offers results in at least one publisher-authored targeting specification, wherein, said publisher-authored targeting specification is transferred to a product selection engine selecting products from said MUP;
means for selecting and customizing a storefront;
means for generating a client-side store-script, wherein said publisher deploys said client-side store script to said web page, wherein a client executes said store script and wherein said store script accesses system servers, said system servers serving up an impression of an advertising unit comprising an online store.

18. The system of claim 17, wherein said store builder comprises:
means for selecting a previously-created targeting specification;
means for customizing a previously-created targeting specification; and
means for creating new targeting specification.

19. The system of claim 16, wherein said performance reporting component provides a publisher with performance data aggregated from raw log files, wherein said performance reporting component provides the publisher with a plurality of views of said performance data.

20. The system of claim 16, wherein said store builder comprises means for generating a trial ad unit based on the product selection and storefront selected, so that the publisher can pre-view the store before going live.

21. The system of claim 1, wherein said advertising unit is self-optimizing, updating product offers in real-time as performance data is analyzed and acted upon, wherein optimizing of product offers includes:
optimizing based on the context of an impression;
optimizing based on history;
optimizing based on product attributes; and optimizing product combinations.
